(19) United States
(12) Patent Application Publication
(10) Pub. No.: US 2006/0274177 A1
(43) Pub. Date: Dec. 7, 2006

(54) Image processing apparatus

(75) Inventors: Yasuo Masaki, Osaka (JP); Yasunari Miyake, Osaka (JP); Hideki Tanabe, Osaka (JP)

Correspondence Address: OSHA LIANG L.L.P., 1221 MCKINNEY STREET, SUITE 2800, HOUSTON, TX, 77010, US

(73) Assignee: Funai Electric Co., Ltd., Daito-shi (JP)

(21) Appl. No.: 11/435,322

(22) Filed: May 16, 2006

(30) Foreign Application Priority Data
May 16, 2005 (JP) P2005-142521

(51) Int. Cl. H04N 5/335

(52) U.S. Cl. 348/308

(57) ABSTRACT

An image processing apparatus includes: an image pickup device that performs a resolution conversion imaging operation of performing imaging on all pixel areas with a resolution, which is lower than a resolution that the image pickup device has, and a partial imaging operation of performing imaging on a region limited to a part of all pixel areas; and an image processing circuit that performs computation on stored image data, and that has a moving body detection function of detecting a region, in which a moving body may be present, from resolution conversion imaging images obtained at different moments, and also has a face detection function of detecting an area, which may represent a face of a person, according to partial image data obtained by a partial imaging operation performed by the image pickup device on the region detected by the moving body detection function.

### BACKGROUND OF THE INVENTION

1. Field of the Invention

The present invention relates to an image processing apparatus for detecting the face of a person from a taken image.

2. Description of the Related Art

Hitherto, various techniques relating to a face detection apparatus or a face recognition apparatus (a face checking apparatus) have been proposed.

For example, a person recognition apparatus described in Japanese Patent No. 3,088,880 is adapted to obtain a difference of an image signal, which is taken by a CCD camera, from a precedent frame and to recognize, when the difference is detected by a threshold value determination portion and a comparison portion to be equal to or more than a predetermined extent, a part, which is represented by the image signal, as a moving object. The person recognition apparatus is also adapted to detect the top portion of the recognized moving object and to specify an image area, which includes a face image, with respect to the top portion. Also, the person recognition apparatus is adapted to identify, in a case where a lateral edge of features, such as an eyebrow, an eye, or a mouth, of a face is detected, the object as a face.

Also, for instance, Japanese Patent No. 3,025,133 describes the aforementioned face recognition technique, that is, the technique of identify, in a case where a lateral edge of features, such as an eyebrow, an eye, or a mouth, of a face is detected, an object as a face. Additionally, the technique of utilizing features relating to an eye, a nose, a mouth, and crow's feet as the features of a face has been proposed (see, for example, JP-A-2002-150288).

Also, the technique of efficiently recognizing an area taken up by a moving object in an image has been proposed (see, for instance, JP-A-10-275237). The technique described in the JP-A-10-275237 is adapted so that the taken image including the moving object is divided into a plurality of blocks, that a block, in which the motion of an object occurs, is detected according to image data representing each block of images of at least two temporally sequenced frames thereby to detect a moving area corresponding to an object, and that subsequently, applying a predetermined shape model of the object to the detected moving area and recognizing a region included in the moving area as an estimated area of the object to thereby recognize the area taken up by the moving object in the image.

Also, an image processing method enabled to perform image processing under an appropriate processing load depending upon a situation has been proposed (see, for example, JP-A-2002-158982). This image processing method is utilized in an image communication system, such as a bidirectional awareness system, and is adapted so that when a user utilizes a bidirectional awareness system function, a low-resolution image is selected, and that when the user utilizes a conference room function, a high-resolution screen is selected.

### SUMMARY OF THE INVENTION

According to the related art techniques, an area including a motion is detected from a taken image. Then, a face image can be detected from the detected area. Any of the related art techniques is adapted so that a face is detected according to an image, which is taken by an image pickup device, by contriving subsequent processing to be performed. The related art techniques do not particularly take processing operations, which are performed in the image pickup device to obtain image data, into consideration. That is, according to any of the related art techniques, all pixel data of pixels of an image taken by using an image pickup device is outputted to an image processing circuit. Then, various processing is performed on the obtained image in the image processing circuit to thereby detect a face.

Meanwhile, it is necessary for detecting an area, which includes a motion, from a taken image to perform high-speed processing in an image pickup device. In this case, it is unnecessary for performing the process of detecting an area, which includes a motion, from the taken image to read and process information on all pixels taken by the image pickup device. The process of detecting such an area may be a rough process of roughly estimating such an area according to information on pixels thinned to some extent. Conversely, a process for detecting, after an area including a motion is detected, a face image from the detected area is required to read information on all of taken pixels in the area and to perform fine processing on the information. According to such a process, it is unnecessary to read all pixels of the taken image. This enables an image pickup device to perform high-speed processing. Also, this enables the saving of the capacity of a memory adapted to temporarily store the read information.

The invention is created in view of such respects. Accordingly, an object of the invention is to provide an image processing apparatus enabled to efficiently perform a face detection process by contriving a processing operation in an image pickup device and combining this processing operation with a process to be performed in an image processing circuit.

According to the invention, there is provided an image processing apparatus having an imaging lens, an image pickup device, an image pickup device drive circuit, an AD conversion circuit adapted to digitalize an imaging output signal, a memory adapted to temporarily store digital image data, and an image processing circuit capable of performing computation on stored image data. This image processing apparatus features that the image pickup device is enabled to perform a resolution conversion imaging operation of performing imaging on all pixel areas with a resolution, which is lower than a resolution which the image pickup device has, and a partial imaging operation of performing imaging on a region limited to a part of all pixel areas, and that the image processing circuit has a moving body detection function of detecting a region, in which a moving body may be present, from resolution conversion imaging images obtained at different moments by performing resolution conversion imaging operations, and also has a face detection function of detecting an area, which may represent a face of a person, according to partial image data obtained by a partial imaging operation performed by the image pickup device on the region detected by the moving body detection function.

That is, the image processing apparatus according to the invention uses an image sensor, which is an image pickup device, in various states, to thereby taken images of different sizes in different image ranges. That is, the location of a face is roughly estimated. Thus, image data having a small number of pixels is sent to a face detection function portion. Consequently, the face detection process can efficiently be performed, so that the entire processing can be achieved at a high speed. Incidentally, the image processing apparatus of the invention is configured by assuming that a person to be detected is not at a standstill. Therefore, the image processing apparatus of the invention does not support pure still images, such as a photograph and a printed material. The image processing apparatus of the invention supports only a case where a picture of a person existing in a real world is taken by a camera. In this case, the image processing apparatus of the invention is effective especially in detecting a face when a picture of a person is taken to be small, as compared with the entire picture, by using a camera adapted to take an image of a wide area.

Incidentally, the resolution conversion imaging operation function may be adapted to be a thinning imaging operation of performing imaging on pixels limited by performing thinning pixels at uniform intervals. Alternatively, the resolution conversion imaging operation function may be adapted to be an arithmetic-mean reading operation of adding up outputs of a plurality of neighboring pixels and reading an addition result as an output from one pixel. According to the invention, a COMS (Complementary Metal-Oxide Semiconductor) sensor is used as an image pickup device. The image pickup device using the CMOS sensor can perform the thinning imaging operation and the arithmetic-mean reading operation, as described above. Incidentally, as long as an image sensor can control reading of information in units of a pixel, any image sensor may be used as the image pickup device. That is, the image pickup device according to the invention is not limited to a COMS sensor.

Also, interframe differences can be used in a detection operation performed by using the moving body detection function. Alternatively, temporal subtractions of horizontal and vertical cumulative addition values can be used.

According to the image processing apparatus of the invention, the location of a face is roughly estimated. Thus, image data having a small number of pixels is sent to a portion adapted to perform a face detection process. Consequently, the face detection process can efficiently be performed, so that the entire processing can be achieved at a high speed. Also, the image processing apparatus of the invention is effective in performing a face detection process especially in a case where a picture of a person is taken to be small, as compared with the entire picture, by using a camera adapted to take an image of a wide area.

### BRIEF DESCRIPTION OF THE DRAWINGS

These and other objects and advantages of this invention will become more fully apparent from the following detailed description taken with the accompanying drawings in which:

FIG. 1 is a functional block diagram illustrating the entire configuration of an image processing apparatus according to a first embodiment of the invention;

FIG. 2 is an explanatory diagram illustrating a first example of a resolution conversion imaging operation (a thinning imaging operation);

FIG. 3 is an explanatory diagram illustrating a second example of a resolution conversion imaging operation (an arithmetic-mean reading operation);

FIGS. 4A to 4G are explanatory schematic diagrams illustrating a moving body detection process and a face detection process (a face recognition process) utilizing temporal subtractions of resolution conversion images in the image processing apparatus according to the first embodiment;

FIG. 5 is a functional block diagram illustrating the entire configuration of an image processing apparatus according to a second embodiment of the invention; and

FIGS. 6A to 6G are explanatory schematic diagrams illustrating a moving body detection process and a face detection process (a face recognition process) utilizing temporal subtractions of resolution conversion images in the image processing apparatus according to the second embodiment.

### DETAILED DESCRIPTION OF THE EMBODIMENTS

Hereinafter, embodiments of the invention are described with reference to the accompanying drawings.

### First Embodiment

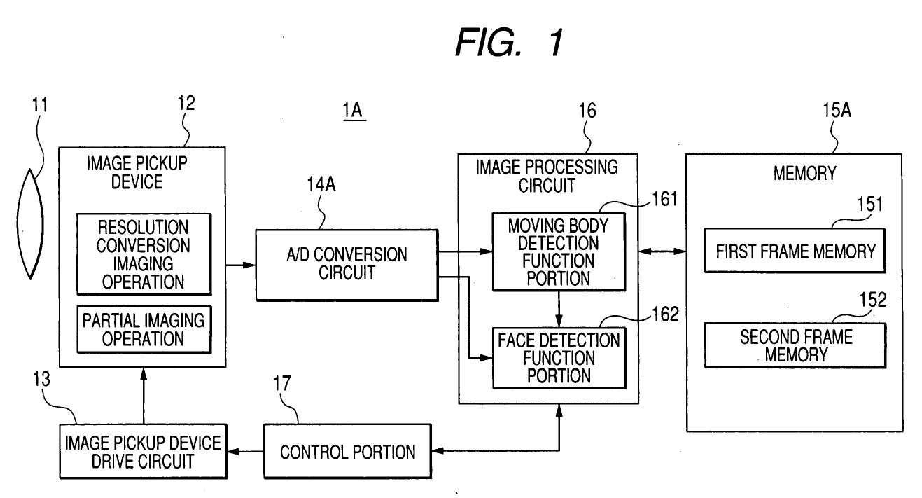

FIG. 1 is a functional block diagram illustrating the entire configuration of an image processing apparatus 1A according to a first embodiment of the invention.

The image processing apparatus 1A according to the first embodiment includes an imaging lens 11, an image pickup device 12, an image pickup device drive circuit 13, an A/D conversion circuit 14A adapted to convert analog imaging output signal, which is outputted from the image pickup device 12, into digital data, a memory 15A adapted to temporarily store digitized image data, an image processing circuit 16 adapted to perform computation on the stored image data, and a control circuit 17 adapted to control the image pickup device drive circuit 13 and the image processing circuit 16.

The image pickup device 12 of the first embodiment is constituted by a CMOS sensor. The CMOS sensor can designate a specific pixel and also can read the specific pixel. Therefore, in the first embodiment, the image pickup device 12 is adapted to perform a resolution conversion imaging operation of performing imaging on all pixel areas with a resolution, which is lower than a resolution that the image pickup device 12 has, and a partial imaging operation of performing imaging on a region limited to a part of all pixel areas, in conjunction with a processing operation of the image processing circuit 6.

The image processing circuit 16 has a moving body detection function portion 161 adapted to detect a region, in which a moving body may be present, from resolution conversion imaging images obtained at different moments by performing resolution conversion imaging operations, and also has a face detection function portion 162 adapted to detect an area, which may represent a face of a person, according to partial image data obtained by a partial imaging operation performed by the image pickup device 12 on the region detected by the moving body detection function portion 161.

The memory 15A is adapted to store a resolution conversion image, which is obtained by the resolution conversion imaging operation of the image pickup device 12, and also store a partial imaging image obtained by the partial imaging operation thereof. Incidentally, the first embodiment is configured to have a first frame memory 151 and a second frame memory 152 so as to store resolution conversion images of two frames.

Hereunder, the image pickup device 12 is more specifically described.

The image pickup device 12 has pixels, the number of which is larger than that of pixels used in image processing for detecting a face. The image pickup device 12 has a resolution of SXGA (Super extended Graphics Array), that is, 1280×1024 pixels. Basically, the image pickup device 12 can scan all pixels to thereby read information that all the pixels have.

As described above, the image pickup device 12 is adapted to perform the partial imaging operation of taking a partial image, the number of which is less than that of all pixels of an image (the partial image has a resolution of, for example, QVGA (Quarter Video Graphics Array), that is, 320×240 pixels, and also perform the resolution conversion imaging operation of performing imaging on all pixel areas with a resolution, which is lower than the resolution that the image pickup device 12 has.

The control portion 17 is a control block adapted to control a detection operation of the moving body detection function portion 161, a detection operation of the face detection function portion 162, and the partial imaging operation and the resolution conversion imaging operation of the image pickup device 12 in conjunction with one another.

Hereinafter, examples of the resolution conversion imaging operation of the image pickup device 12 are described.

### FIRST EXAMPLE

In a first example, the image pickup device 12 performs a resolution conversion imaging operation of taking an image of pixels by thinning the pixels at uniform intervals under the drive control of the image pickup device drive circuit 13, which is performed by the control portion 17. The image pickup device 12 is adapted to read outputs of the remaining pixels. That is, the resolution conversion imaging operation of the first example is a thinning imaging operation of performing imaging on pixels limited by performing thinning pixels at uniform intervals. In this case, an angle of view is the same as that obtained in the case of reading information on all the pixels by scanning all the pixels, while a resolution differs from that obtained in the case of reading information on all the pixels. The number of pixels to be read is reduced by thinning the pixels. In that sense, high-speed reading of the pixels can be achieved.

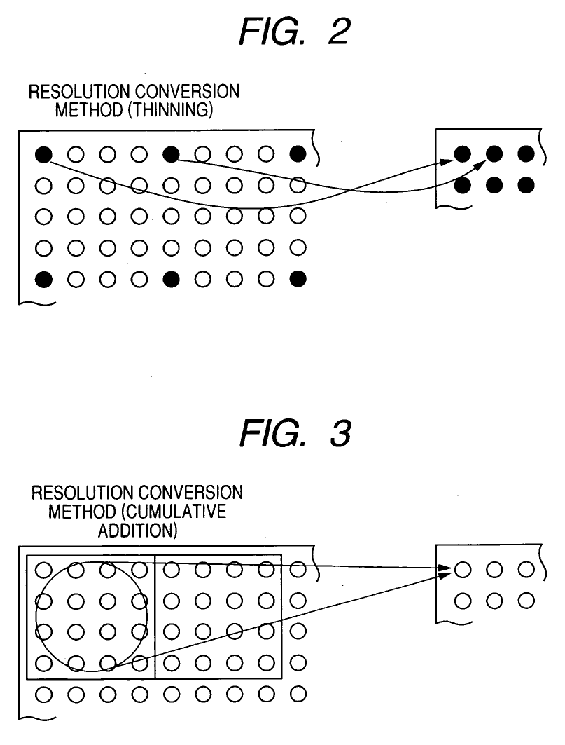

FIG. 2 is an explanatory diagram illustrating the first example of the resolution conversion imaging operation (the thinning imaging operation). Incidentally, FIG. 2 is an enlarged diagram illustrating a part of the pixels of the image pickup device 12.

In the first example, among outputs of all pixels to be read, an output of one pixel (indicated by a black circle in FIG. 2) sampled every four pixel both in a horizontal direction and a vertical direction is read, that is, three pixels between the adjacent sampled pixels are thinned. Thus, a low resolution is obtained to be ( 1/16) of the resolution obtained in the case of reading all the pixels. Practically, the resolution of 1280×1024 pixels is reduced to a resolution of 320×256 pixels. Incidentally, FIG. 2 shows only one example. A thinning interval is not limited thereto.

### SECOND EXAMPLE

In a second example, the image pickup device 12 performs an arithmetic-mean reading operation (another kind of a resolution conversion imaging operation) of adding outputs of neighboring pixels of each of a plurality of sets and outputting an addition results as an output from one pixel corresponding to the set of the neighboring pixels, whose outputs are added, under the drive control of the image pickup device drive circuit 13. The image pickup device 12 is adapted to read the outputted addition results. In this case, an angle of view is the same as that obtained in the case of reading information on all the pixels by scanning all the pixels, while a resolution differs from that obtained in the case of reading information on all the pixels. The number of pixels, the addition results respectively corresponding to which should be read, is reduced from the number of all pixels by adding outputs of neighboring pixels of each of a plurality of sets and outputting an addition results as an output from one pixel corresponding to the set of the neighboring pixels, whose outputs are added. In that sense, high-speed reading of the pixels can be achieved.

FIG. 3 is an explanatory diagram illustrating the second example of a resolution conversion imaging operation (an arithmetic-mean reading operation). Incidentally, FIG. 3 is an enlarged diagram illustrating a part of the pixels of the image pickup device 12.

In the second example, outputs of 4×4 neighboring pixels of each of a plurality of sets are added. Then, an addition result is outputted as an output from one pixel corresponding to the set of the neighboring pixels, whose outputs are added. Thus, a low resolution is obtained to be ( 1/16) of the resolution obtained in the case of reading all the pixels. Practically, the resolution of 1280×1024 pixels is reduced to a resolution of 320×256 pixels. Incidentally, FIG. 3 shows only one example. The number of the neighboring pixels, whose outputs are added, is not limited thereto. For example, the second embodiment may be modified so that outputs of 3×3 neighboring pixels of each of a plurality of sets are added, and that an addition result is outputted as an output from one pixel corresponding to the set of the neighboring pixels, whose outputs are added.

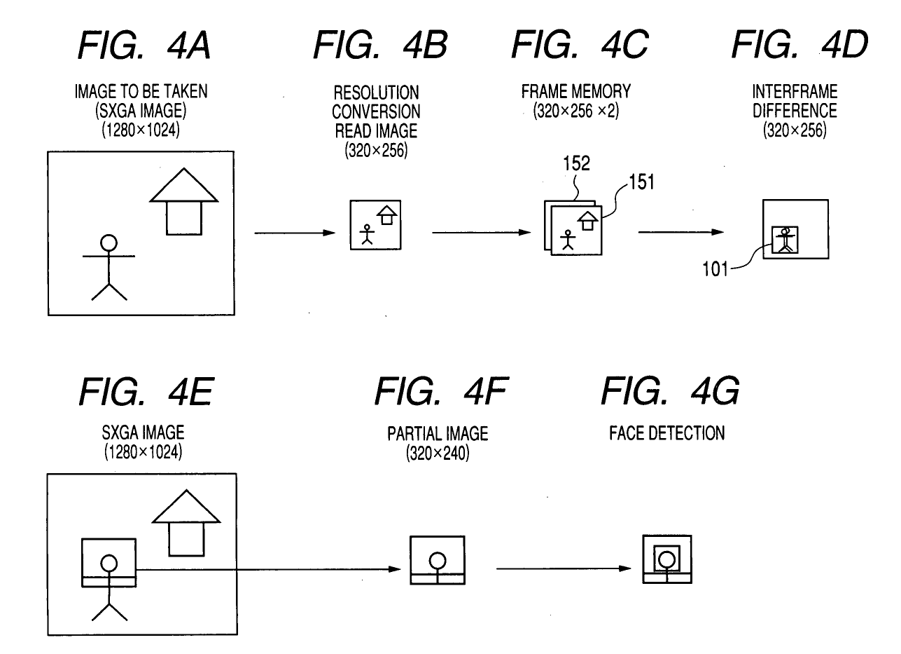

Next, a moving body detection process and a face detection (or face recognition) process performed in the image processing apparatus 1A of the aforementioned configuration according to the temporal subtractions of resolution conversion images, which is obtained by utilizing the resolution conversion imaging operation of one of the first example and the second example, is described by referring to a schematic diagram shown in FIGS. 4A to 4G.

For instance, when the designation of a moving body detection process mode is inputted from an input portion (not shown), the control portion 17 performs the drive control of the image pickup device drive circuit 13 to thereby cause the image pickup device 12 to perform one of the resolution conversion imaging operation of one of the first example and the second example. Thus, the image pickup device 12 outputs a resolution conversion read image shown in FIG. 4B, which has a low resolution and is obtained from an image (or SXGA image) shown in FIG. 4A to be taken. Then, the A/D conversion circuit 14 converts the resolution conversion read image into digital image data. Subsequently, the digital image data is inputted to the image processing circuit 16. Then, the image processing circuit 16 causes, for example, a first frame memory 151 of a memory 15A, which is used for a partial image (or a low resolution image), to temporarily store the received image data.

Hereinafter, a image of the resolution conversion imaging operation of the image pickup device 12 is described.

In the moving body detection mode, the aforementioned process is repeated 30 times per second. That is, images of 30 frames are taken for 1 second. Then, the aforementioned process is performed on the image of each of the frames. Incidentally, the images of the frames are sequentially stored in the memory 15A by overwriting the images of the frames alternately to the first frame memory 151 and the second frame memory 152. Consequently, image data respectively corresponding to different moments (that is, two temporally sequenced frames) are stored therein (see FIG. 4C).

On the other hand, the moving body detection function portion 161 of the image processing circuit 16 compares the image data, which is stored in the first frame memory 151, with the image data, which is stored in the second frame memory 152, and computes interframe differences under the control by the control portion 17. Then, the moving body detection function portion 161 performs binarization so that the value at a portion (or pixel), at which the difference between pixels respectively located at the corresponding positions in two frames is equal to or larger than a specific threshold value, is set to be 1, and that the value at each of the other portions (or pixels) is set to be 0. Then, a partial area 101 having pixels of the QVGA pixel number is determined so that the number of the included pixels having a value of 1 is maximized (see FIG. 4D). That is, the partial area 101 is an area in which a moving body may be present.

When the partial area 101 is determined, the control portion 17 performs the drive control of the image pickup device drive circuit 13 to thereby cause the image pickup device 12 to perform a partial imaging operation (see FIG. 4E). That is, the image pickup device 12 takes an image of the partial area 101 of the image to be taken (the SXGA image) shown in FIG. 4E and outputs the partial image shown in FIG. 4F. Then, the partial image is converted at the A/D conversion circuit 14 into digital image data. Subsequently, the digital image data is inputted to the image processing circuit 16.

On the other hand, the face detection function portion 162 of the image processing circuit 16 performs face detection from the received image data, which represents the partial image, by using a face detection algorithm under the control of the control portion 17 (see FIG. 4G). Then, information representing the number of detected faces (incidentally, this number includes 0) and the positions and the sizes of the detected faces is outputted to an apparatus connected to a subsequent stage (not shown). Hitherto, various techniques have been proposed as the face detection algorithm. Any of such various techniques may be employed. Although the detail description of such techniques is omitted herein, a face can be detected or recognized by, for example, detecting a gradation change occurring in a face (that is, the gradation change occurring among an eyebrow, an eye, a nose, and a mouth).

### Second Embodiment

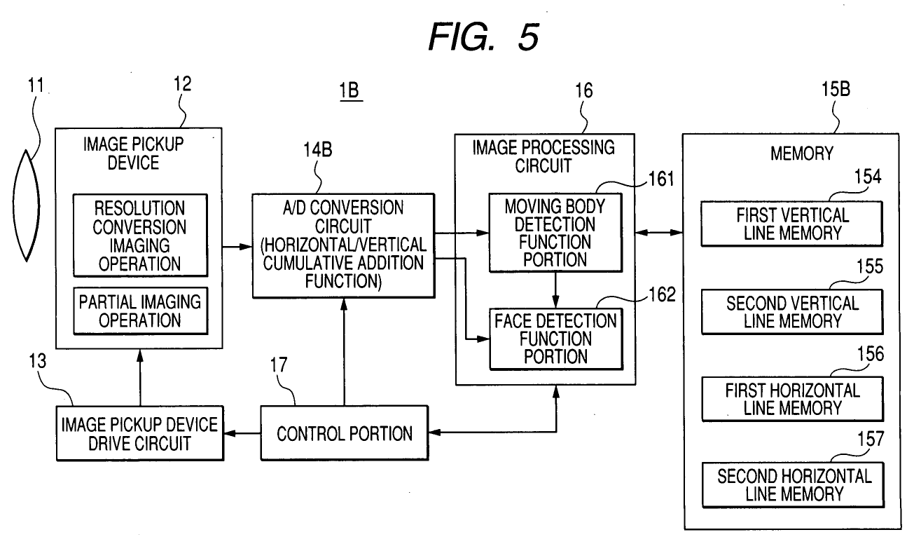

FIG. 5 is a functional block diagram illustrating the entire configuration of an image processing apparatus 1B according to a second embodiment of the invention.

The image processing apparatus 1B according to the second embodiment includes an imaging lens 11, an image pickup device 12, an image pickup device drive circuit 13, an A/D conversion circuit 14B having a horizontal/vertical cumulative addition function, a memory 15B adapted to temporarily store digitized image data, an image processing circuit 16 adapted to perform computation on the stored image data, and a control circuit 17 adapted to control the image pickup device drive circuit 13 and the image processing circuit 16.

Incidentally, the configuration of the image pickup device 12 is similar to that of the image pickup device of the first embodiment and is adapted to perform the resolution conversion imaging operation and the partial imaging operation described in the foregoing description of the first example and the second example.

The image processing circuit 16 of the second embodiment is basically the same as that of the first embodiment in configuration. That is, the image processing circuit 16 has a moving body detection function portion 161 adapted to detect a region, in which a moving body may be present, from resolution conversion imaging images obtained at different moments, and also has a face detection function portion 162 adapted to detect an area, which may represent a face of a person, according to partial image data obtained by the partial imaging operation performed by the image pickup device 12 on the region detected by the moving body detection function portion 161. However, the moving body detection function portion 161 of the second embodiment slightly differs in detection operation from that of the first embodiment. This will be described later.

The horizontal cumulative addition function of the A/D conversion circuit 14B is to perform the cumulative addition of values of all pixel data representing all pixels on the same line (corresponding to a horizontal direction). The vertical cumulative addition function of the A/D conversion circuit 14B is to perform the cumulative addition of values of all pixel data representing all pixels on the same column (corresponding to a vertical direction). The A/D conversion circuit 14B converts the cumulative addition value of all image data representing all pixels on the same line and the cumulative addition value of all image data representing all pixels on the same column, which are obtained by performing these functions, to digital data. Then, the A/D conversion circuit 14B outputs the digital data to the image processing circuit 16. Incidentally, these cumulative addition functions are performed when the detection process is performed by the moving body detection function portion 161 of the image processing circuit 16 (to be described later). However, these cumulative addition functions are not performed when the detection process is performed by the face detection function portion 162.

In the second embodiment, the memory 15B has first and second vertical line memories 154 and 155 adapted to store the cumulative addition values, each of which is obtained by performing the cumulative addition of all image data representing all pixels on the same line, corresponding to all lines, respectively, and also has first and second horizontal line memories 156 and 157 that store the cumulative addition values, each of which is obtained by performing the cumulative addition of all image data representing all pixels on the same column, corresponding to all columns, corresponding to all columns, respectively.

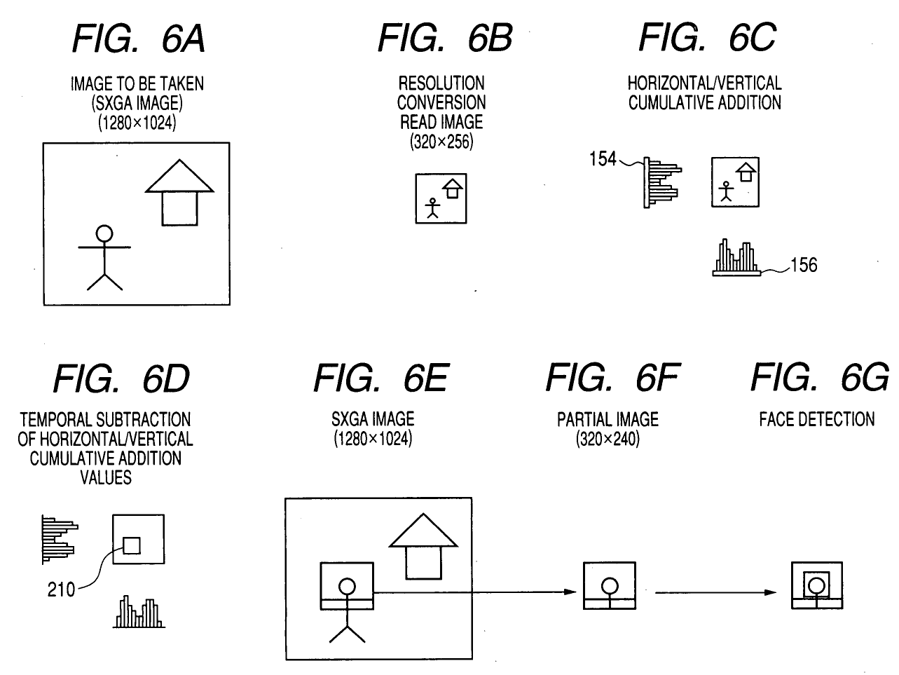

Next, a moving body detection process and a face detection (or face recognition) process performed in the image processing apparatus 1B of the aforementioned configuration according to the temporal subtractions of resolution conversion images, which is obtained by utilizing the resolution conversion imaging operation of one of the first example and the second example, is described by referring to a schematic diagram shown in FIGS. 6A to 6G.

For example, when the designation of a moving body detection process mode is inputted from an input portion (not shown), the control portion 17 performs the drive control of the image pickup device drive circuit 13 to thereby cause the image pickup device 12 to perform one of the resolution conversion imaging operation of one of the first example and the second example. Thus, the image pickup device 12 outputs a resolution conversion read image shown in FIG. 6B, which has a low resolution and is obtained from an image (or SXGA image) shown in FIG. 6A to be taken. The A/D conversion circuit 14B performs the cumulative addition of values represented by all pixel data corresponding to the pixels on the same line (extending in a horizontal direction) of an image, which is represented by image data shown in FIG. 6B, by utilizing the horizontal cumulative addition function. Then, the A/D conversion circuit 14B converts the cumulative addition values into digital data, and also outputs the digital data to the image processing circuit 16. Also, the A/D conversion circuit 14B performs the cumulative addition of values represented by all pixel data corresponding to the pixels on the same column (extending in a vertical direction) of an image, which is represented by image data shown in FIG. 6B, by utilizing the vertical cumulative addition function. Then, the A/D conversion circuit 14B converts these cumulative addition values into digital data, and also outputs the digital data to the image processing circuit 16. The image processing circuit 16 causes, for instance, the first vertical line memory 154 to store the received cumulative addition values corresponding to all the columns, each of which is obtained by the cumulative addition of values represented by all pixel data corresponding to the pixels on the same column. Also, the image processing circuit 16 causes, for example, the second horizontal line memory 156 to store the received cumulative addition values corresponding to all the lines, each of which is obtained by the cumulative addition of values represented by all pixel data corresponding to the pixels on the same line (see FIG. 6C).

In the moving body detection mode, the aforementioned process is repeated 30 times per second. That is, images of 30 frames are taken for 1 second. Then, the aforementioned process is performed on the image of each of the frames. Incidentally, the cumulative addition value obtained by performing the cumulative addition of the values representing the pixels on the same line of each of frames is stored in the vertical line memories by overwriting the cumulative addition values alternately to the first vertical line memory 154 and the second vertical line memory 155. Further, the cumulative addition value obtained by performing the cumulative addition of the values representing the pixels on the same column of each of frames is stored in the horizontal line memories by overwriting the cumulative addition values alternately to the first horizontal line memory 156 and the second horizontal line memory 157. Consequently, image data respectively corresponding to different moments (that is, two temporally sequenced frames) are stored therein.

On the other hand, the moving body detection function portion 161 of the image processing circuit 16 compares the cumulative addition values respectively corresponding to the lines, which are stored in the first vertical line memory 154, with the cumulative addition values respectively corresponding to the lines, which are stored in the second vertical line memory 155. Then, the moving body detection function portion 161 computes differences in cumulative addition value between lines extending in a horizontal direction under the control by the control portion 17. Also, the moving body detection function portion 161 compares the cumulative addition values respectively corresponding to the columns, which are stored in the first horizontal line memory 156, with the cumulative addition values respectively corresponding to the columns, which a restored in the second horizontal line memory 157. Then, the moving body detection function portion 161 computes differences in cumulative addition value between columns extending in a vertical direction under the control by the control portion 17. Then, the moving body detection function portion 161 performs binarization so that each of the value at a portion (or line/column), at which the difference in cumulative addition value corresponding to the same line between lines extending in a horizontal direction and the difference in cumulative addition value corresponding to the same column between lines extending in a vertical direction is equal to or larger than a specific threshold value, is set to be 1, and that the value at each of the other portions (or pixels) is set to be 0. Then, a partial area 201 having pixels of the QVGA pixel number is determined so that the number of the included lines/columns having a value of 1 is maximized (see FIG. 6D) That is, the partial area 201 is an area in which a moving body may be present.

When the partial area 201 is determined, the control portion 17 performs the drive control of the image pickup device drive circuit 13 to thereby cause the image pickup device 12 to perform a partial imaging operation (see FIG. 6E). That is, the image pickup device 12 takes an image of the partial area 201 of the image to be taken (the SXGA image) shown in FIG. 6E and outputs the partial image shown in FIG. 6F. Then, the partial image is converted at the A/D conversion circuit 14 into digital image data. Subsequently, the digital image data is inputted to the image processing circuit 16.

On the other hand, the face detection function portion 162 of the image processing circuit 16 performs face detection from the received image data, which represents the partial image, by using a face detection algorithm under the control of the control portion 17 (see FIG. 6G). Then, information representing the number of detected faces (incidentally, this number includes 0) and the positions and the sizes of the detected faces is outputted to an apparatus connected to a subsequent stage (not shown). Hitherto, various techniques have been proposed as the face detection algorithm. Any of such various techniques may be employed. Thus, the detail description of such techniques is omitted herein.

The image processing apparatus according to the invention can be utilized for personal authentication using a monitoring camera. Also, new functions relating to a remote control operation can be added to the image processing apparatus by mounting the image processing apparatus on a television receiver or on a playback unit of a DVD recorder.

What is claimed is:

1. An image processing apparatus comprising:
an imaging lens;
an image pickup device that includes a CMOS image sensor, and that is adapted to perform a resolution conversion imaging operation of performing imaging on all pixel areas with a resolution, which is lower than a resolution that the image pickup device has, and a partial imaging operation of performing imaging on a region limited to a part of all pixel areas;
an image pickup device drive circuit;
an AD conversion circuit adapted to digitalize an imaging output signal;
a memory adapted to temporarily store digital image data; and
an image processing circuit that performs computation on stored image data, and that has a moving body detection function of detecting a region, in which a moving body may be present, from resolution conversion imaging images obtained at different moments by performing resolution conversion imaging operations, and also has a face detection function of detecting an area, which may represent a face of a person, according to partial image data obtained by a partial imaging operation performed by the image pickup device on the region detected by the moving body detection function, wherein:
the resolution conversion imaging operation function is to perform an arithmetic-mean reading operation of adding outputs of neighboring pixels of each of a plurality of sets and outputting an addition results as an output from one pixel corresponding to the set of the neighboring pixels, whose outputs are added; and
the moving body detection function uses temporal subtractions of horizontal and vertical cumulative addition values.

2. An image processing apparatus comprising:
an imaging lens;
an image pickup device that performs a resolution conversion imaging operation of performing imaging on all pixel areas with a resolution, which is lower than a resolution that the image pickup device has, and a partial imaging operation of performing imaging on a region limited to a part of all pixel areas;
an image pickup device drive circuit;
an AD conversion circuit adapted to digitalize an imaging output signal;
a memory adapted to temporarily store digital image data; and
an image processing circuit that performs computation on stored image data, and that has a moving body detection function of detecting a region, in which a moving body may be present, from resolution conversion imaging images obtained at different moments by performing resolution conversion imaging operations, and also has a face detection function of detecting an area, which may represent a face of a person, according to partial image data obtained by a partial imaging operation performed by the image pickup device on the region detected by the moving body detection function.

3. The image processing apparatus according to claim 2, wherein
the resolution conversion imaging operation function is a thinning imaging operation of performing imaging on pixels limited by performing thinning pixels at uniform intervals.

4. The image processing apparatus according to claim 2, wherein
the resolution conversion imaging operation function is an arithmetic-mean reading operation of adding outputs of neighboring pixels of each of a plurality of sets and outputting an addition results as an output from one pixel corresponding to the set of the neighboring pixels, whose outputs are added.

5. The image processing apparatus according to claim 2, wherein
the image pickup device is constituted by a CMOS image sensor.

6. The image processing apparatus according to claim 2, wherein
the moving body detection function uses interframe differences.

7. The image processing apparatus according to claim 2, wherein
the moving body detection function uses temporal subtractions of horizontal and vertical cumulative addition values.
